(19) United States
(12) Patent Application Publication
(10) Pub. No.: US 2007/0269347 A1
(43) Pub. Date: Nov. 22, 2007

(54) MICROSCOPE SLIDE INCUBATION AND PROCESSING SYSTEM

(76) Inventors: James E. Stanchfield, Sunnyvale, CA (US); Kevin Heyes, Milpitas, CA (US)

Correspondence Address: INTELLECTUAL PROPERTY LAW OFFICES, 1901 S. BASCOM AVENUE, SUITE 660, CAMPBELL, CA, 95008, US

(21) Appl. No.: 11/749,656

(22) Filed: May 16, 2007

Related U.S. Application Data
(60) Provisional application No. 60/802,015, filed on May 18, 2006.

(51) Int. Cl. B01L 3/00

(52) U.S. Cl. 422/99

(57) ABSTRACT

A system for processing laboratory materials is presented which includes a heating apparatus having a heated base portion, a heated lid portion and a cavity. One or more chambers are included which are configured to fit within the cavity of the heating apparatus. Each chamber includes an enclosure, one or more slide racks for holding multiple microscope slides, and an absorbent pad for providing humidity. A solution bath and a micro-tube block are configured to fit within the cavity. A handle is included for attachment to one or more of the racks for transporting the racks from the chamber to the solution bath.

This application claims priority to provisional application 60/802,015, filed May 18, 2006 to the present inventors.

### TECHNICAL FIELD

The present invention relates generally to equipment for processing of laboratory specimens and more particularly to equipment for the incubation of materials at elevated temperatures and humidity.

### BACKGROUND ART

Several commonly used molecular analysis procedures require incubation of microscope slides with biological samples deposited on the surface at elevated temperatures and humidity. Included in these procedures are so-called micro-array analysis tests that involve hybridization of nucleic acids probes to many distinct samples of DNA or RNA deposited across the surface of the slide. Other techniques that require incubation of slides at elevated temperatures and humidity include hybridization of nucleic probes in situ to tissue sections or cells attached to the slide and the binding of antibodies to samples of tissues, cells or discrete proteins. Other common characteristics of all of the previously described procedures is the incubation of multiple slides at one time and the submerging of the group of slides after incubation into one or a series of solutions held at various temperatures.

The most common laboratory procedure for incubating slides used in micro-array analysis, and frequently in in situ hybridization and antibody binding protocols employs a two piece, re-sealable, waterproof cassette. This cassette seals up to five slides using an o-ring and multiple fasteners around its periphery. After placement of the slides and sealing of the cassette, the assembly is placed at the bottom of a waterbath set at the temperature required for the incubation. After a period of time that can be as short as an hour or as long as several days, the cassette is removed from the waterbath, dried with paper towels and then disassembled. The slides are then removed very quickly, one by one from the cassette and placed in a suitable rack which is then quickly placed in a tray containing a solution which is frequently held at temperature above room temperature. Failure to remove the slides quickly from the cassette and getting them submerged in solution leads to drying of the sample which ruins the test.

Thus there is a need for a processing system which allows handling of multiple microscope slides at once, and which allows multiple stages of processing within a single apparatus and associated accessories.

### DISCLOSURE OF INVENTION

Accordingly, it is an advantage of the present invention that it presents a system by which incubation of materials can be done in a highly regulated isothermal environment.

Another advantage of the present invention is that it presents a system in which multiple microscope slides can be processed without the necessity of handling slides individually during the heating and solution phases.

And another advantage of the present invention is that it presents a system in which a heating apparatus is adapted for processing multiple micro-tubes, multiple slides and a solution bath, all in one device.

A further advantage of the present invention is that it provides one or more chambers for containing multiple racks of microscope slides.

An additional advantage of the present invention is that it provides one or more chambers for processing materials where each chamber is fitted with an water saturated absorbent pad which provides a source of elevated humidity for processing multiple microscope slides at elevated temperatures without condensation on the slides.

Yet another advantage of the present invention is that it presents an apparatus for incubation of materials in which the apparatus includes both a heated base and a heated lid portion to produce a highly regulated isothermal environment.

A yet further advantage of the present invention is that it uses a small, multipurpose, benchtop dry-heating unit smaller than a standard laboratory waterbath frees up valuable bench space and eliminates water spills and leaks.

An additional advantage of the present invention is that it preferably includes a heating unit that can regulate the temperature of devices used with the heating unit to +/−0.1° C., superior to the +/−0.5 to 1.0 degree C. regulation achieved in waterbaths.

A further advantage of the present invention is that it preferably includes a removable chamber that can be inserted in the benchtop unit which can hold 8 or more microscope slides and can be sealed with four fasteners, compared to standard waterbath cassettes which hold a maximum of 5 slides and typically require six fasteners to seal.

Still another advantage of the present invention is that it preferably includes a rack with handle that can be reversibly removed from the chamber which holds microscope slides in a configuration for performing both the incubation and post processing steps. These features eliminate handling of the microscope slides after incubation and minimizes the potential of air drying and contamination or damaging of the samples.

Another advantage is the ability to reversibly join two or more racks with a handle to increase the number of slides that can processed simultaneously.

An additional advantage of the present invention is that it preferably includes a water saturated absorbent pad that attaches to the inside top cover of the chamber above the slides and provides a humidified environment during heated incubations without condensation forming on any surfaces of the slides. This compares with prior art devices which use a water reservoir below the slides, which leads to condensation forming on slide surfaces and contamination of the samples.

A further advantage of the present invention is that it preferably includes removable blocks that fit in the heating unit that can hold different types of micro-tubes. This allows the same benchtop heating unit to be used for performing the incubation steps required when preparing samples for microscope slide analysis. Having the same unit used for performing multiple steps saves space by eliminating the need for other heating units.

Yet another advantage of the present invention is that it preferably includes the use of a hinged, heated lid which heats the air above the micro-tubes placed in the removable blocks during sample incubations thereby preventing condensation from forming on the tube caps. Partial condensation results in sample partitioning and changes in the ionic environment of the main body of the sample. Condensation also makes complete sample recovery problematic.

An additional advantage of the present invention is that it preferably includes an open metal tray that can be reversibly used in the heating unit to hold and heat solutions used for processing microscope slides held in microscope racks. This provides a fast and convenient means of placing a group of microscope slides into a solution held at an elevated temperature after incubation.

A further advantage of an alternate embodiment of a chamber of the present invention is that the chamber enclosure is preferably provided with feet which raise it from sitting in direct contact with the heated base plate, and the chamber is also provided with a carrying handle.

Briefly, one preferred embodiment of the present invention is a system for processing laboratory materials which includes a heating apparatus having a heated base portion, a heated lid portion and a cavity. One or more chambers are included which are configured to fit within the cavity of the heating apparatus. Each chamber includes an enclosure, one or more slide racks for holding multiple microscope slides, and an absorbent pad for providing humidity. A solution bath and a micro-tube block are configured to fit within the cavity. A handle is included for attachment to one or more of the racks for transporting the racks from the chamber to the solution bath.

These and other advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows an isometric view of an incubation apparatus and two chambers of the present invention;

FIG. 2 shows an exploded isometric view of a chamber assembly for the system of the present invention, with slide racks in vertical position;

FIG. 3 shows an isometric view of an incubation apparatus and solution bath insert with slide racks of the present invention in horizontal position;

FIG. 4 shows an isometric view of an incubation apparatus and micro-tube block insert of the present invention with micro-tubes strip and micro-well plate

FIG. 5 shows an isometric view of reconfigured slide racks with carrying handle of the present invention, with the interlocking slide racks in horizontal position;

FIG. 6 shows a top plan view of reconfigured interlocking slide racks with carrying handle of the present invention, with the slide racks in horizontal position;

FIG. 7 shows an isometric view of a single slide rack with carrying handle of the present invention, with the slide rack in horizontal position: and

FIG. 8 shows an exploded isometric view of an alternate embodiment of a chamber assembly for the system of the present invention.

### BEST MODE FOR CARRYING OUT THE INVENTION

The present invention is a system for incubating and processing laboratory materials, which will be designated in the following discussion and figures as processing system 10.

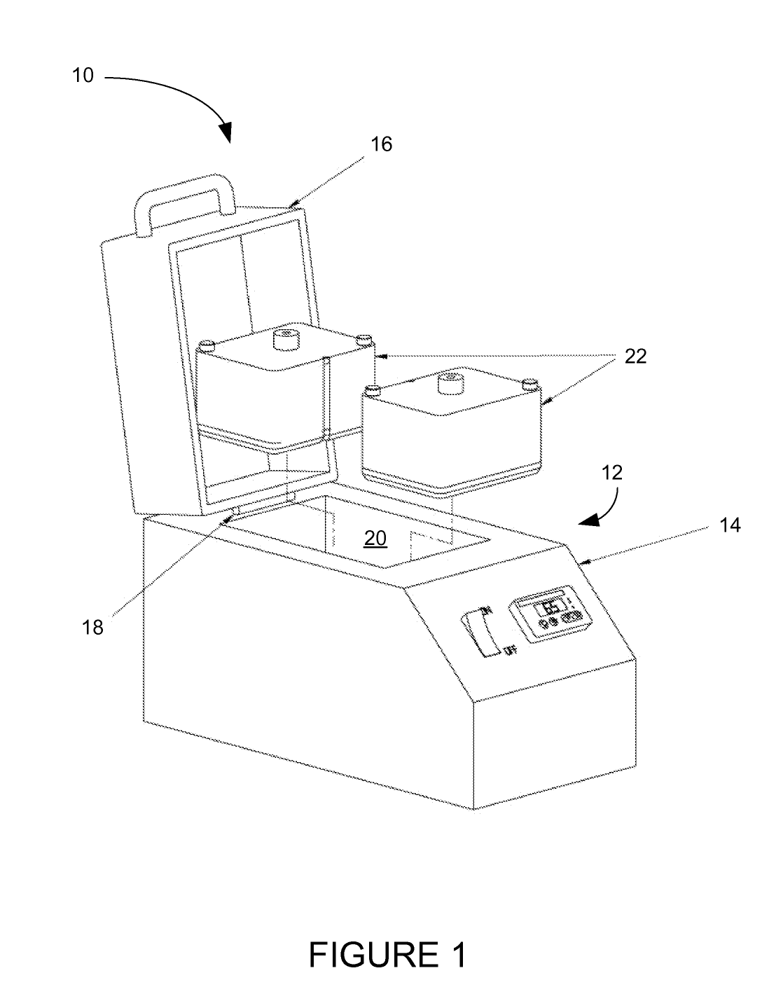

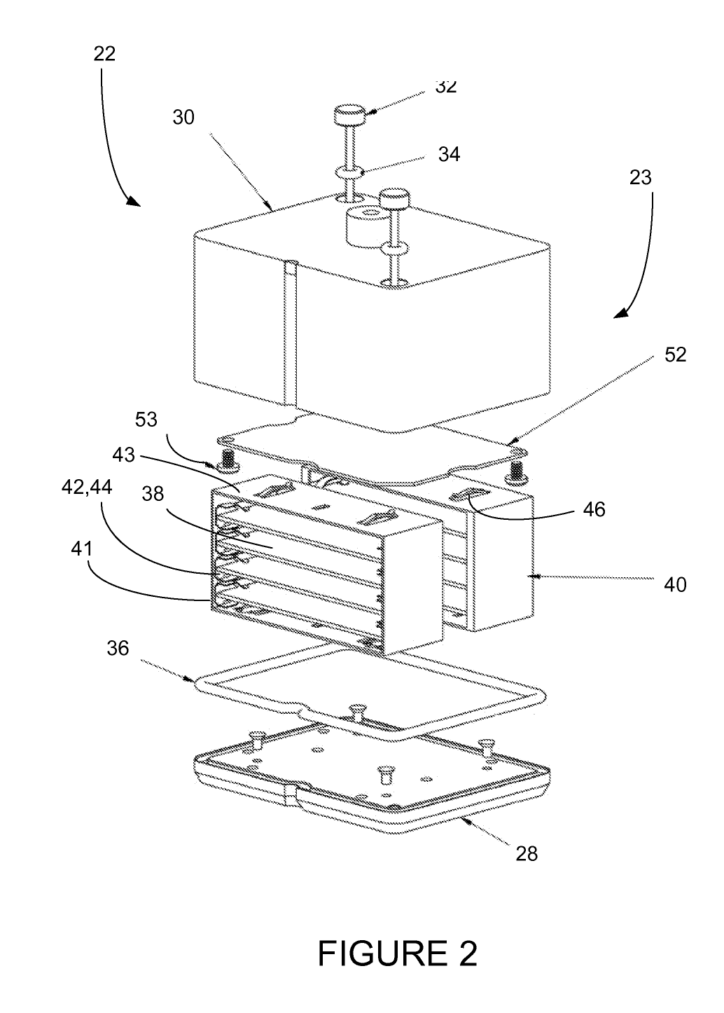

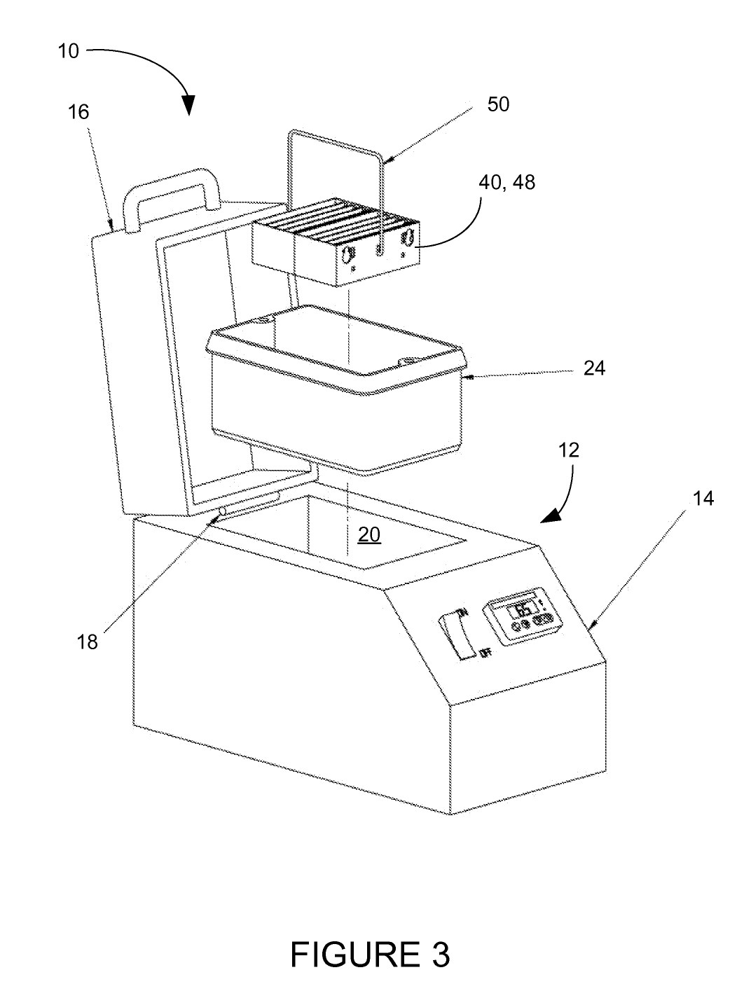

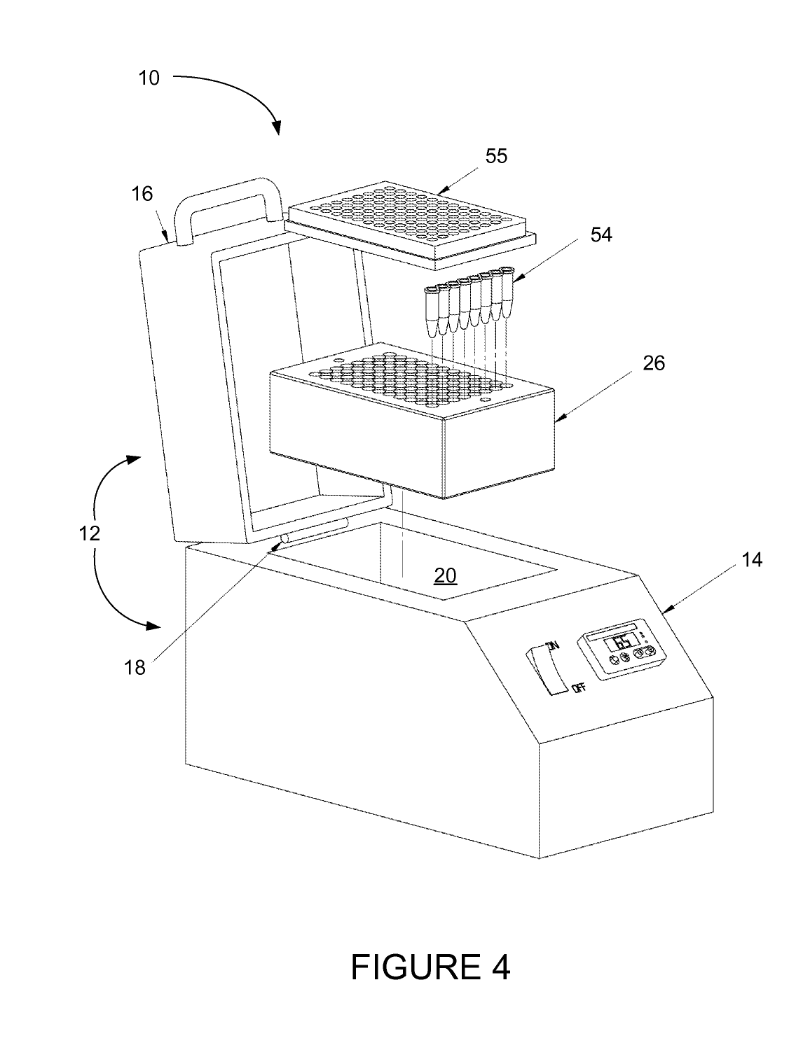

As shown in FIGS. 1-4, the processing system 10 includes a heating apparatus 12 having a heated base portion 14 and a heated lid portion 16, which are attached by a hinge 18 as shown especially in FIG. 1. The heating apparatus 12 includes a cavity 20 which is configured to receive one or more chambers 22, (see FIG. 2), a solution basin 24 (see FIG. 3) or a micro-tube block 26 with either micro-tubes 54 or a micro-well plate 55 (see FIG. 4).

FIG. 2 shows a detail exploded view of elements of one of the chambers 22, having an enclosure 23 which includes a base plate 28, and cover 30, which are held together by fasteners 32, having O-rings 34 to maintain an air-tight seal. A gasket 36 is preferably included to further maintain the seal. A water-saturated absorbent pad 52 attaches with fasteners 53 to the inside top cover 30 of the chamber 22 above the slides 38, held in racks 40 by fasteners 42. This provides a humidified environment during heated incubations without condensation forming on any surfaces of the slides. This is in contrast to the prior art, in which water placed in a reservoir below the slides leads to condensation forming on slide surfaces and contamination of the samples.

The heating apparatus 12 is preferably a small, multipurpose, benchtop dry-heating unit smaller than a standard laboratory waterbath, which thus frees up valuable bench space and eliminates water spills and leaks. This heating unit 12 preferably can regulate the temperature of devices used with the heating unit to +/−0.1° C., superior to the +/−0.5 to 1.0° C. regulation achieved in waterbaths. The removable chamber 22 can be inserted in the benchtop heating unit, and preferably can hold 10 or more microscope slides and can be sealed with two fasteners. Standard waterbath cassettes hold a maximum of 5 slides and require six fasteners to seal.

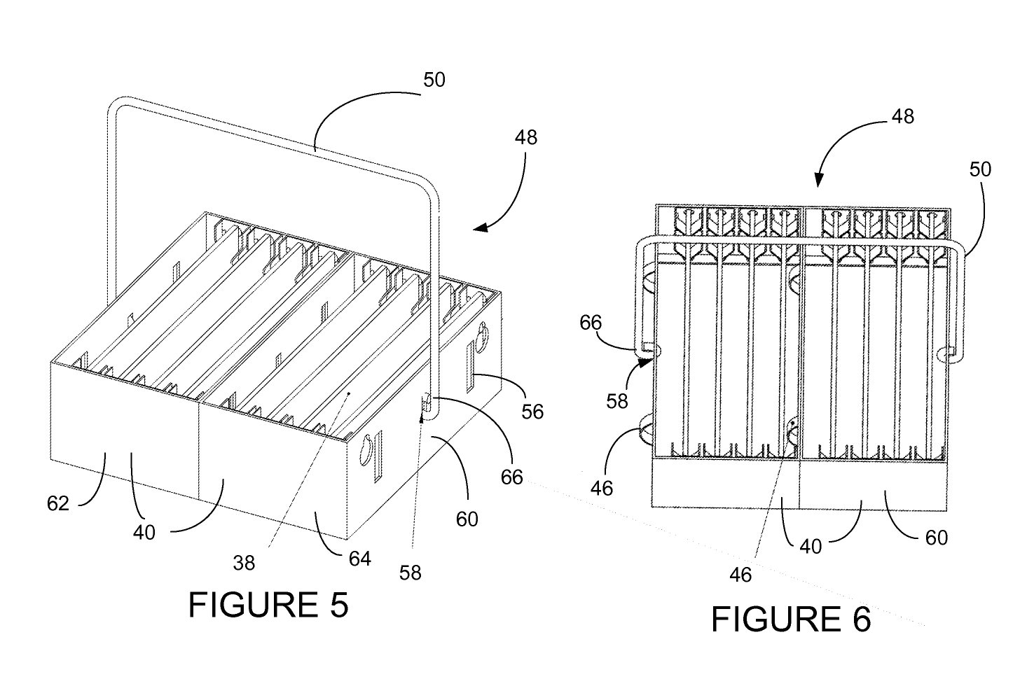

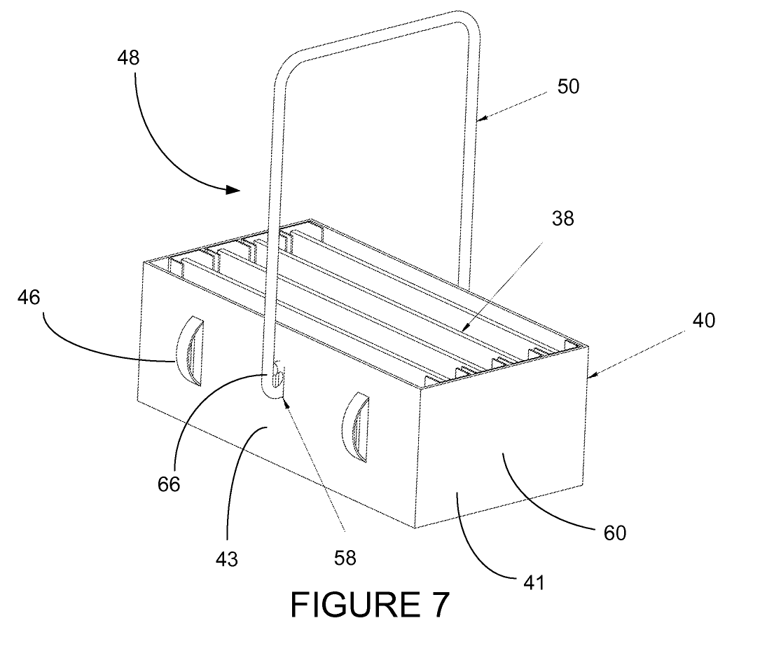

As shown in FIG. 2, the racks 40 are mounted vertically, so that the slides 38 are oriented horizontally inside the chamber 22, which is then placed in the heating apparatus 12 for processing. FIG. 1 shows chambers 22 containing the microscope slide racks 40 being used with the heating apparatus 12, and FIGS. 5-7 show the slide racks 40 in more detail. Referring now also to FIG. 2, within the chamber enclosure 23, a number of microscope slides are held by one or more racks 40, of which two are shown in the FIGS. 2 and 5-6, and a single rack 40 is shown in FIG. 7. The slides are held in the racks 40 by fasteners 42, preferably clips 44 which are attached to the end walls 41. The side walls 43 of the racks 40 also include side clips 46, mounting slots 56, and handle slots 58 formed in the rack enclosure 60.

The rack 40 with handle 50 can be reversibly removed from the chamber 22 and holds microscope slides 38 in a configuration for performing both the incubation and post processing steps. These features eliminate handling of the microscope slides 38 after incubation and minimize the potential of air drying of the samples.

When the incubation stage is completed, the chambers 22 are removed from the heating apparatus 12, and the racks 40 are removed from the chambers 22. The slides 38 remain in the racks 40, and thus reduce the amount of handling and processing time required. The racks 40 are then turned horizontally, the slides 38 now being vertical, as seen in FIGS. 3, and 5-7. The horizontal racks 40 can now be placed side by side as shown in FIGS. 3, 5 and 6, and the side clips 46 of a first rack 62 used to engage the mounting slots 56 of a second rack 64, so that they are releasably fastened together in a single transportable unit 48 to which a handle 50 may be attached for easy handling. This is done by inserting the handle ends 66 into the handle slots 58 of the rack enclosure 60.

The transportable unit 48 can then be carried to the heating apparatus 12 again and optionally inserted into a solution basin 24 (see FIG. 3) which is then placed into the cavity of the heating apparatus 12. The solution basin 24 is preferably an open metal tray that can be used in the heating unit 12 to hold and heat solutions used for processing microscope slides 38 held in the rack 40. This provides a fast and convenient means of placing a group of microscope slides 38 into a solution after incubation. A major advantage here is again that the same heating apparatus is used for all stages of this process, rather than using separate devices, as is common in the prior art.

FIG. 7 shows a single rack 40 being attached with a handle 50 for transport, as it is quite possible to process each rack 40 separately, rather than in pairs as discussed above, and as before, the slides 38 are not handled individually, but are handled as a group to expedite processing.

FIGS. 2, 3, 5 and 6 show 2 racks 40, each holding sets of 4 slides each, but it is to be understood that each rack could include 10 or more slides, and that a single, larger capacity rack in a larger chamber could be used with the heating apparatus 12 shown. It will also be obvious to those skilled in the art that the size and capacity of the heating apparatus, the size and capacity of the chamber or chambers, the included racks and number of the slides in each rack can be varied greatly, so that a heating apparatus with a larger cavity could be configured to hold more or larger chambers and racks and consequently more slides.

Returning to FIG. 4, as referred to above, a removable micro-tube block 26 fits in the heating unit 12, and can hold different types of micro-tubes 54 and micro-well plates 55. This allows the same benchtop heating unit to be used for performing the incubation steps required when preparing samples for microscope slide analysis. Having the same unit used for performing multiple steps saves space by eliminating the need for other heating units.

The micro-tube block 26 and micro-well plate 55 are shown in the same figure as a matter of convenience, but it is to be understood that they are preferably to be used independently of each other. The heating apparatus 12 is preferably not configured to hold both at the same time, although this is not to be considered a limitation, and it is possible that a larger capacity unit could be made which would hold both simultaneously.

The hinged, heated lid 16 heats the air above the micro-tubes 54 placed in the removable blocks 26 during sample incubations thereby preventing condensation from forming on the tube caps. Partial condensation results in sample partitioning and changes in the ionic environment of the main body of the sample. Condensation also makes complete sample recovery problematic. Thus these disadvantages of the prior art are eliminated in the present invention 10.

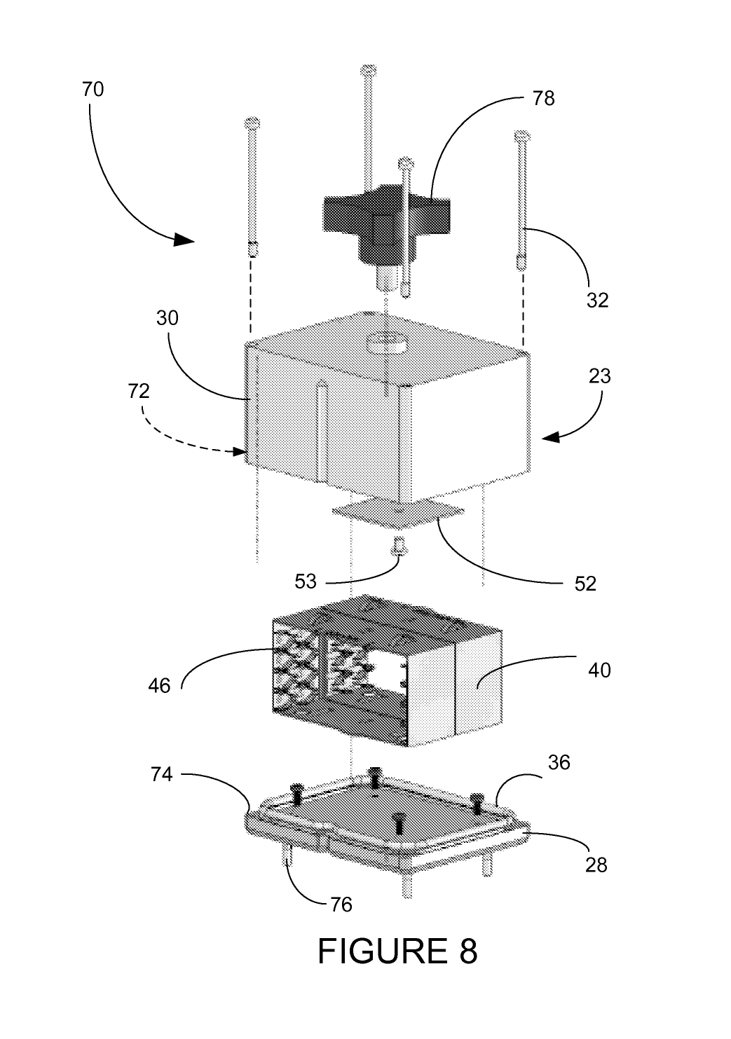

An alternate embodiment of a chamber 70 is shown in FIG. 8, which is an exploded isometric view. Once again it includes an enclosure 23 which includes a base plate 28, and cover 30, which are held together by fasteners 32, preferably four fasteners at the corners, which fit through channels 72 in the cover 30 to engage screw threads 74 in the base plate 28. A gasket 36 is used maintain an air-tight seal. A water-saturated absorbent pad 52 attaches by a fastener 53 to the inside top cover 30 of the chamber 22 above the slide racks 40. The embodiment 70 shown preferably includes slots for four slides to be held by clips 46, but this is not to be construed as a limitation.

Also preferably included are four feet 76 mounted at the bottom of the baseplate 28, which allow better air circulation in the heating apparatus. A carrying handle 78 is also preferably included.

While various embodiments have been described above, it should be understood that they have been presented by way of example only, and not limitation.

### INDUSTRIAL APPLICABILITY

The present system for processing laboratory materials 10 is well suited for application in laboratory applications generally and especially for several commonly used molecular analysis procedures which require incubation of microscope slides with biological samples deposited on the surface at elevated temperatures and humidity. Included in these procedures are so-called micro-array analysis tests that involve hybridization of nucleic acids probes to many distinct samples of DNA or RNA deposited across the surface of the slide. Other techniques that require incubation of slides at elevated temperatures and humidity include hybridization of nucleic probes in situ to tissue sections or cells attached to the slide and the binding of antibodies to samples of tissues, cells or discrete proteins. Other common characteristics of all of the previous procedures is the incubation of multiple slides at one time and the submerging of the group of slides after incubation into one or a series of solutions held at various temperatures.

The present system 10 is particularly well-suited for these operations, and combines several features and processing steps into a single unit, which previously had to be performed by separate devices.

The system 10 includes a heating apparatus 12, which is preferably a small, multipurpose, benchtop dry-heating unit smaller than a standard laboratory waterbath, which thus frees up valuable bench space and eliminates water spills and leaks. This heating unit 12 preferably can regulate the temperature of devices used with the heating unit to +/−0.1° C., which is superior to the +/−0.5 to 1.0° C. regulation achieved in waterbaths. The removable chamber 22 can be inserted in the benchtop heating unit, and preferably can hold 8 or more microscope slides and can be sealed with four fasteners.

Racks 40 hold the slides inside the chamber 22, which is then placed in the heating apparatus 12 for processing. The slides are held in the racks 40 by fasteners 42, preferably clips 44. The racks 40 also include side clips 46, mounting slots 56, and handle slots 58 formed in the rack enclosure 60.

The rack 40 with handle 50 can be removed from the chamber 22 and holds microscope slides 38 in a configuration for performing both the incubation and post processing steps. These features eliminate handling of the microscope slides 38 after incubation and minimize the potential of air drying and contamination or damage of the samples.

When incubation stage is completed, the chambers 22 are removed from the heating apparatus 12, and the racks 40 are removed from the chambers 22. The slides 38 remain in the racks 40, and thus reduce the amount of handling and processing time required. The racks 40 are then turned horizontally, which can now be placed side by side and the side clips 46 of a first rack 62 used to engage the mounting slots 56 of a second rack 64, so that they are releasably fastened together in a single transportable unit 48 to which a handle 50 may be attached for easy handling. This is done by inserting the handle ends 66 into the handle slots 58 of the rack enclosure 60.

The transportable unit 48 can then be carried to the heating apparatus 12 again and optionally inserted into a solution basin 24 which is then placed into the cavity of the heating apparatus 12. The solution basin 24 is preferably an open metal tray that can be reversibly used in the heating unit 12 to hold and heat solutions used for processing microscope slides 38 held in the rack 40. This provides a fast and convenient means of placing a group of microscope slides 38 into a solution after incubation. A major advantage here is again that the same heating apparatus 12 is used for all stages of this process, rather than using separate devices, as is common in the prior art.

A removable micro-tube block 26 fits in the heating unit 12, as well and can hold different types of micro-tubes 54 and micro-well plates 55. This allows the same benchtop heating unit to be used for performing the incubation steps required when preparing samples for microscope slide analysis. Having the same unit used for performing multiple steps saves space by eliminating the need for other separate heating units.

The hinged, heated lid 16 heats the air above the micro-tubes 54 placed in the removable blocks 26 during sample incubations thereby preventing condensation from forming on the tube caps. Partial condensation results in sample partitioning and changes in the ionic environment of the main body of the sample. Condensation also makes complete sample recovery problematic. Thus these disadvantages of the prior art are eliminated in the present invention 10.

Thus the system of the present invention 10 combines the functions of several previous devices, thus reducing required space, reducing cost, and producing superior results without the disadvantages of condensation in the specimens.

For the above, and other, reasons, it is expected that the system for processing laboratory materials 10 of the present invention will have widespread industrial applicability. Therefore, it is expected that the commercial utility of the present invention will be extensive and long lasting.

What is claimed is:

1. A heating apparatus for processing laboratory materials, comprising:
a heated base portion; and
a heated lid portion, where said heated base portion and said heated lid portion surround a cavity, wherein said cavity is configured to hold one or more laboratory devices chosen from a group consisting of chambers, slide racks, solution basins, micro-tube blocks and micro-well plates.

2. A chamber apparatus for processing laboratory materials, comprising:
an enclosure;
one or more racks for holding multiple microscope slides; and
an absorbent pad for providing humidity.

3. The chamber apparatus of claim 2, further comprising:
a cover;
a base plate; and
a gasket interposed between said cover and said base plate such that said cover, said base plate and said gasket form an air-tight enclosure surrounding a chamber cavity.

4. The chamber apparatus of claim 3, wherein:
said absorbent pad attaches to the inside of said cover.

5. The chamber apparatus of claim 3, further comprising:
fasteners which attach said cover to said base plate, said fasteners including O-rings which maintain an air-tight seal.

6. The chamber apparatus of claim 3, wherein:
said chamber cavity is configured to hold at least one slide rack.

7. A slide rack for holding a plurality of laboratory slides, comprising:
a rack enclosure;
a plurality of fasteners placed to hold said plurality of laboratory slides;
side clips and mounting slots formed on said rack enclosure, such that side clips from a first rack can engage mounting slots in a second rack to attach said first and second racks into a transportable unit.

8. The slide rack of claim 7, further comprising:
handle slots formed in said rack enclosure, such that a handle can be inserted into said handle slots so that said attached racks of said transportable unit can be easily carried.

9. A transportable unit for processing laboratory materials, comprising:
at least two attachable slide racks, which are connected by side clips of a first slide rack which engage mounting slots of a second slide rack; and
a handle which engages handle slots in said first and second slide racks.

10. A system for processing laboratory materials, comprising:
a heating apparatus having a heated base portion, a heated lid portion which surround a cavity;
at least one chamber configured to fit within said cavity, each chamber including:
an enclosure;
at least one slide rack for holding multiple microscope slides; and
an absorbent pad for providing humidity;
a solution bath configured to fit within said cavity; and
a handle for attachment to said at least one rack for transporting said rack from said chamber to said solution bath.

11. The system of claim 10 further comprising:
a micro-tube block configured to fit within said cavity.

12. The system of claim 11 further comprising:
a micro-well plate configured to fit within said cavity upon said micro-tube block.

13. The system of claim 10 wherein said chamber apparatus comprises:
an enclosure;
one or more racks for holding multiple microscope slides; and
an absorbent pad for providing humidity.

14. The system of claim 13 wherein said chamber apparatus further comprises:
a cover;
a base plate; and
a gasket interposed between said cover and said base plate to form an air-tight seal.

15. The system of claim 14 wherein:
said absorbent pad attaches to the inside of said cover.

16. The system of claim 14 wherein said chamber further comprises:
fasteners which attach said cover to said base plate, said fasteners including O-rings which maintain an air-tight seal.

17. The system of claim 10 wherein said slide rack comprises:
a rack enclosure;
a plurality of fasteners placed to hold said plurality of laboratory slides; and
side clips and mounting slots formed on said rack enclosure, such that side clips from a first rack can engage mounting slots in a second rack to attach said racks into a transportable unit.

18. The system of claim 17 wherein said slide rack further comprises:
handle slots formed in said rack enclosure, such that a handle can be inserted into said handle slots so that said attached racks of said transportable unit can be easily carried.
